(19) United States
(12) Patent Application Publication
(10) Pub. No.: US 2006/0107310 A1
(43) Pub. Date: May 18, 2006

(54) Method for authorization of service requests to service hosts within a network

(75) Inventors: Stefan Schmid, Heidelberg (DE); Marcus Brunner, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/261,470

(22) Filed: Oct. 31, 2005

(30) Foreign Application Priority Data
Nov. 17, 2004 (DE) 10 2004 055 505.2

(51) Int. Cl. H04L 9/32

(52) U.S. Cl. 726/4

(57) ABSTRACT

A method for authorization of service requests to service hosts within a network, wherein the communication within the network is based on a routing mechanism, according to which user terminals within the network are associated with routable network addresses, is characterized in that the service host sends a nonce included in a request message to the network address of a requesting user terminal, and that the user terminal resends the nonce or a value inferable from the nonce by the service host as well as by the user terminal included in a response message to the network address of the service host.

### BACKGROUND OF THE INVENTION

1. Field of the Invention

The present invention relates to a method for authorization of service requests to service hosts within a network, wherein the communication within the network is based on a routing mechanism according to which user terminals within the network are assigned to routable network addresses.

2. Description of the Related Art

Methods of this kind have been known in practice for some time in several variations. The authorization methods known usually rely on an explicit security association at the service host, for example as user accounts, user certificates or a public key infrastructure (PKI).

In particular with regard to network-side services which increasingly gain importance, the methods known are problematic though. Examples for network-side services, which enable specific processing capabilities of user-side data traffic, are firewalls, NATs (network address translators), caches, intelligent packet processing nodes, smart gateways or programmable routers. While for network administrators secure means, for example based on user authentication and access control, are already available in order to configure these network-side services, end-users do typically not have any explicit security association (for example, a user account or a user certificate) with these services at their disposal. Consequently, it is not possible for end-users to use for themselves the provided advantages of network-side functionality, i.e. for the data traffic originated from or destined for them.

### SUMMARY OF THE INVENTION

The present invention is now based on the task to indicate a method of the above captioned kind which provides with easy means, i.e. in particular without the necessity of an explicit security association, for many kinds of services a level of security which enables end-users to use these services.

The above captioned problem is solved by a method showing the characteristics of patent claim 1. According to the present invention, the method is designed and further developed in such a way that the service host sends a nonce included in a request message to the network address of a requesting user terminal and in such a way that the user terminal resends the nonce or a value inferable from the nonce by the service host as well as by the user terminal, included in a. response message to the network address of the service host.

According to the invention, it has first been recognized that for the authorization of services, especially, a multitude of network-side services, the validation of the network address of a requesting user terminal provides a sufficient level of security. Furthermore, according to the invention and regarding the validation of the network address of a service requesting user terminal, a simple request-response protocol between service host and requesting user terminal is given. Here, the service host sends a request message including a nonce to the network address of a requesting user terminal. The nonce can be any arbitrary value, for example a sufficiently large random value whereby it only has to be ensured that it is almost impossible for a malicious user to guess the nonce. According to the invention, the user terminal sends—included in a response message—the nonce itself or a value inferable from the nonce by the service host as well as by the user terminal back to the network address of the service host. The method according to the invention hence enables the validation of the network addresses of requesting user terminals and allows detecting malicious users who request the usage of a service with a faked network address.

As the request-response protocol according to the invention is used in a similar way like known standard “challenge-response” protocols, it should in particular be pointed out here that the method according to the invention does not rely on a pre-established shared secret between the user terminal and the service host. Such an established secret is mandatory for the secure operation of standard challenge-response protocols. The security of the method proposed by the invention derives instead from the routing characteristics of the network environment in which the method is applied. In this case, the characteristic of routed networks of forwarding the request message only to the node (or the sub-network of the node) to which the network address to be verified belongs to is taken advantage of.

Regarding the kind of addresses that can be verified, the method according to the invention is applicable in a wide scope. The only pre-requisite is that the addresses must be routed in the network. In this sense, in particular, Internet protocol addresses can be verified, i.e. IPv4 or IPv6 addresses as well as SIP URLs used for voice-over IP applications.

The method according to the invention enables end-users without an explicit user account to take advantage of the network-side services providing value-added functionality within the network for their own data flows, i.e. for data packets that are sent to or from their user terminal. In this sense, users can for example configure a network-side firewall or a NAT middle box for their own data flows or in case that their user terminal must be reachable from the public network, for example for a VoIP application, they can request a port-to-address translation from a NAT gateway.

In the context of a concrete implementation, it can be provided that the service host enables the requested service only if the nonce received along with the response message matches the nonce sent. In other words, the service request will only be processed if the user terminal has sent back the correct nonce (or a value inferred from it) to the network address of the service host. By these means, it is possible to deny access to a requested service to a malicious user who claims to be someone else by a faked network address. Instead of enabling the service for unlimited access, and depending on the network address of the requesting user terminal, an enabling of the service with a limited scope can be performed.

In case that the user terminal receives a request message from a service host without having sent a service request to the service host, it can be provided in an advantageous way that the user terminal sends a negative acknowledgement to the service host. By these means the service host is indicated problems that occurred when validating a network address and in turn it can directly abort processing the corresponding service request.

In the context of a further beneficial embodiment it is provided that the service host waits for a pre-settable period of time after receipt of a valid response message before it enables the requested service. This is particularly beneficial for broadcast media such as, for example, non-switched Ethernet networks because here a malicious user on the local broadcast medium is able to intercept the local traffic. Consequently, he can fake a valid response message even though the request message was sent to the correct network address of an actually requesting user. In case of such an attack, the requesting user receives typically also the request message. As a consequence, he can use the idle time of the service host (the time until the service will be enabled) to send an alert, for example in the form of a negative acknowledgement, to the service host. It should be noted that the cases where attacks of the described kind are possible, are reduced by the fact that most of the “last-hop-link” technologies develop into the direction of “non-broadcast” or switched media (such as switched Ethernet, GPRS/UMTS etc.).

In case the service host does not receive a response message within a configurable period of time, it can also be provided that the processing of the service request is aborted.

Regarding a higher level of security, the used nonce which is included in a request and response message, can be extended by a hash chain. By these means, a provably secure communication between the user terminal and the service host can be realized, though the necessary processing effort increases due to the fact that messages are generated. This is especially beneficial if the same user terminal sends several service requests to the service host. By doing so, the time usable for an attack in broadcast media is reduced to the time of the first exchange.

In the framework of a further advantageous embodiment, it can be provided that the request message and the response message are assigned an identification (ID). This is especially beneficial in such a case where during a specific time interval a multitude of service requests arrive at a service host. Based on the ID an initial service request can be easily and unambiguously matched with a response message.

Now, there are several options of how to design and to further develop the tenet of the present invention in an advantageous way. For this purpose, it must be referred to the subordinate patent claims on the one hand and to the following explanation of examples of preferred embodiments of the invention on the other hand. In connection with the explanation of the preferred embodiments of the invention according to the drawing, generally preferred designs and further developments of the tenet will also be explained.

### BRIEF DESCRIPTION OF THE DRAWINGS

FIG. 1 is a schematic diagram showing an embodiment of the method for authorization of service requests to a service host according to the present invention;

FIG. 2 is a schematic diagram showing a situation in which a service request is sent by a malicious user terminal; and

FIG. 3 is a schematic illustration showing another embodiment of the method according to the invention wherein the service request refers to the configuration of a network-side firewall.

### DETAILED DESCRIPTION OF THE PREFERRED EMBODIMENTS

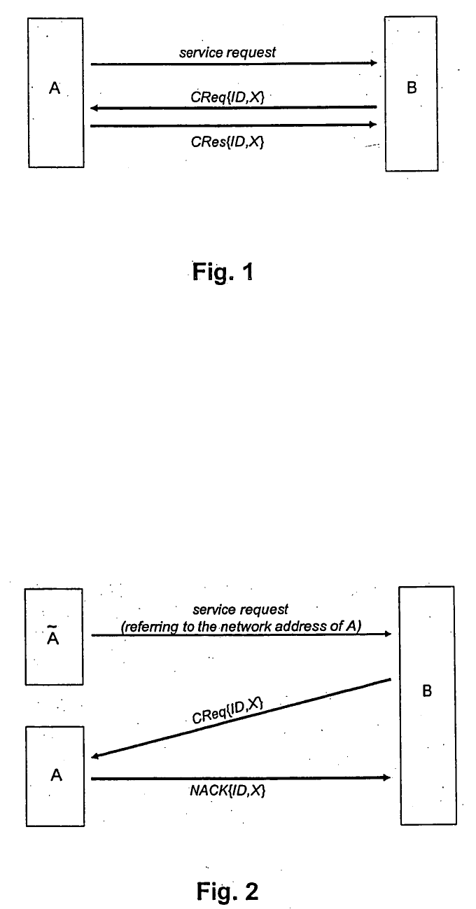

FIG. 1 depicts in a diagram—schematically—an example of an embodiment of a method according to the invention for authorization of service requests to service hosts within a network. After the service host B has received a service request from the user terminal A, the service host B sends a request message CReq{ID, X} to the network address of the sender, i.e. to the network address of user terminal A. The request message CReq{ID, X} contains a nonce X which can be any arbitrary value, for example a sufficiently large random value. Regarding the selection of the nonce X, it only has to be made sure that it is almost impossible for a malicious user to guess the nonce X.

Due to the routing mechanism of the network it is ensured that the request message CReq{ID,X} is exclusively forwarded to the sub-network of the user terminal to which the network address to be verified belongs. Nodes/terminals of any other sub-network are hence not able to intercept this message.

The response message CRes{ID,X} of the user terminal A whose network address is to be verified, comprises also the nonce X or—alternatively—another value which can be inferred unambiguously from the nonce X by the user terminal A as well as by the service host B. Since the nonce X as provided by the service host B as a part of the request message CReq{ID,X} is formed in such a way that a malicious user is not able to guess it, there is no way for a malicious user to fake a valid response message CRes{ID, X}. If the service host B receives a valid response message CRes {ID, X}, it hence knows that the network address included in the original service request is valid. Consequently, the requested service can be enabled for the user terminal A.

As also depicted in FIG. 1, the request message CReq{ID, X} and the response message CRes{ID, X} do—in addition to the nonce X—also comprise an identification ID. The latter is needed to match the response message CRes{ID, X} unambiguously with the original service request. The identification ID can for example be formed as a hash value or it can be derived from the application number or from an internal numbering of requests of the user terminal.

FIG. 2 depicts in a schematic diagram the situation in which a malicious user Ã sends a service request to service host B and feigns being user A. In accordance with the method according to the invention, the service host B which receives the service request, first asks the user who has sent the service request to verify his network address together with a request message CReq{1D, X}. Since the service request is faked by the malicious user Ã, service host B believes that user A has sent the service request and consequently sends the request message CReq{ID, X} to the network address of user A. But user A does not know anything of a service request and answers therefore with a negative acknowledgement NACK{ID, X}. By doing so, the service host B is informed about the problem and can abort the processing of the original service request.

It should be noted that the method can also be performed in such a way that even if user terminal A does not send a negative acknowledgement NACK{ID, X) to service host B, the processing of the service request is aborted by service host B, if no response message CRes{ID, X) is received after a configurable period of time.

The example depicted in FIG. 2 illustrates very clearly that the security of the method according to the invention does not only result from the request-response protocol alone, but from the application of the protocol in the context of a routed network environment in which it is guaranteed due to an appropriate routing that the request message CReq{ID, X} is correctly and exclusively sent to the network address to be validated and/or to the corresponding sub-network.

Furthermore, it should be added that a malicious user located on the data path between user terminal A and service host B, can easily intercept the request message CReq{ID,X). Consequently, he can fake the corresponding response message CRes{ID, X} and so make the service host B believe that the network address was validated. Due to the lack of a shared secret of the user terminal and the service host or a reliable PKI (Public Key Infrastructure), it is not possible to avoid this kind of attack in the framework of the method according to the invention. But as the access network typically “belongs” to the service provider, in whom the user has to trust regarding the provision of a secure network infrastructure anyway, this kind of attack does in general not represent a major threat.

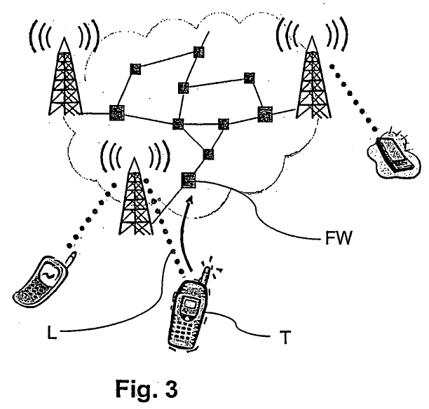

The scenario depicted in FIG. 3 shows another application example of the method according to the invention. In the example shown, a mobile terminal T is relieved by relocating its firewall functionality or some of its aspects to the network-side firewall FW which filters the packets for the mobile terminal T instead of the mobile terminal T doing this itself. This relocation of functionality to the network-side firewall FW is indicated by the arrow shown in the fig.

In order to make sure that a mobile terminal T on the network-side firewall FW only can configure those firewall rules which have impact on the data traffic sent to or from this mobile terminal T, first of all the network address of the mobile terminal T is validated. This takes place following the method according to the invention, as it has been illustrated as an example in the context of FIG. 1. After successful validation of the network address of the mobile terminal T, this terminal T can configure the personal firewall settings without the need of an explicit security association.

Since it is not important for this application who the actual user is or whose terminal it is, there is no need for an explicit security association between the user/user terminal and the network provider running the firewall service. The requirement of an explicit security association would make this depicted application almost impossible on a global scale because a full-fletched PKI including all services and all mobile users/terminals would be required.

For mobile terminals, the access to services without explicit security association is very useful, especially for roaming. Whereas in the home network of a user possibly a full security association exists, this is in general not the case in foreign networks. Nevertheless, the user can use some network-side services with the aid of the method according to the invention.

The described relocation of firewall functionality to a network-side firewall FW has multiple advantages for the mobile terminal T. So, for instance, the communication load on the wireless link L can be reduced considerably, as unwanted traffic can already be blocked in the network.

Moreover, the duration of operation of the—battery-powered—mobile terminal T is increased since no unwanted traffic has to be received and processed. In other words, the time period during which the mobile terminal T can remain in power save mode, can be prolonged. Furthermore, the processing and/or memory capabilities of terminal T can be reduced if the firewall functionality is not performed locally, but already in the network. After all, DoS (Denial of Service) attacks can also be prevented since unwanted packets can already be dropped before reaching the wireless link L. Hence, all in all the wireless bandwidth is not unnecessarily strained.

Finally, it is in particular to be pointed out that the examples of an embodiment of above are only meant to illustrate the claimed tenet, but that they do by no means restrict the latter to the examples of an embodiment.

1. A method for authorization of service requests to service hosts in a network, wherein the communication within the network is based on a routing mechanism, according to which user terminals within the network are associated with routable network addresses,
wherein the service host sends a nonce included in a request message to the network address of a requesting user terminal, and that the user terminal resends the nonce or a value inferable from the nonce by the service host as well as by the user terminal included in a response message to the network address of the service host.

2. The method according to claim 1, wherein the service host enables the requested service if the nonce received along with the response message matches the nonce sent.

3. The method according to claim 1, wherein the service host enables the requested service if the value received along with the response message matches a value inferable from the nonce sent.

4. The method according to claim 1, wherein the user terminal sends a negative acknowledgement to the service host if it receives a request message from the service host without having sent a service request to the service host.

5. The method according to claim 1, wherein the service host waits for a configurable period of time after receipt of a valid response message before it enables the requested service.

6. The method according to claim 1, wherein the service host aborts the processing of the service request if it does not receive a response message within a configurable period of time.

7. The method according to claim 1, wherein the nonce or the value received along with the response message comprises a hash chain or any other asymmetric security mechanism without authorized certificates.

8. The method according to claim 1, wherein the request message and the response message include an identification.

9. The method according to claim 1, wherein the network address can specifically also be an IP address, a session initiation protocol (SIP) URL (uniform resource locator), a H.323 address or a MAC address in switched networks.
